(19) United States
(12) Patent Application Publication
(10) Pub. No.: US 2009/0130342 A1
(43) Pub. Date: May 21, 2009

(54) OPTICAL SHEET FOR DISPLAY AND METHOD FOR PRODUCING AND PACKAGING THE SAME

(76) Inventor: Keisuke Endo, Shizuoka (JP)

Correspondence Address: BIRCH STEWART KOLASCH & BIRCH, PO BOX 747, FALLS CHURCH, VA, 22040-0747, US

(21) Appl. No.: 12/066,612

(22) PCT Filed: Sep. 8, 2006
(86) PCT No.: PCT/JP2006/318315

§ 371 Date: Aug. 26, 2008

(30) Foreign Application Priority Data
Sep. 12, 2005 (JP) 2005-264459
Sep. 12, 2005 (JP) 2005-264460

(51) Int. Cl. B32B 7/04

(52) U.S. Cl. 428/1.3; 156/182; 206/454

(57) ABSTRACT

An optical sheet, an optical sheet for a display and a method for producing an optical sheet for a display suitable for producing a high quality optical sheet in a simple method without decrease in adhesion strength upon bonding optical sheets are provided. A coating film of an aqueous solution containing a water-soluble antistatic agent and a fluorine surfactant is formed on optical sheets whose plane size is equal to or larger than a product size in a thickness after drying of 0.03 to 0.2 g/m². After stacking the optical sheets, the optical sheets are bonded at one or more joining parts, and periphery of a laminate of the optical sheets after bonding is cut into the product size.

### TECHNICAL FIELD

The present invention relates to an optical sheet for a display, a method for producing the same, a package of an optical sheet for a display and a method for packaging the same, and relates to, for example, a technique for producing and packaging an optical sheet for a display in which a prism sheet and a light diffusion sheet are integrated.

### BACKGROUND ART

Recently, films such as light guide plates which diffuse light from, a light source and lens films which focus light in the front direction have been used for electronic displays such as liquid crystal display devices and organic light emitting diodes.

In such applications, various optical films (sheets) are often used with being stacked. Japanese Patent Laid-Open No. 2004-184575 provides a semi-transmissive, semi-reflective polarizing film in which a reflective polarizing film, a retardation film and a semi-transmissive, semi-reflective layer are stacked in an optional order with an absorption type polarizing film being further stacked outside the three layers. The publication describes that as many as five films are present between a light source device and a liquid crystal cell, and such configuration improves screen luminance and reduces power consumption.

Japanese Patent Laid-Open No. 7-230001, Japanese Patent No. 3123006 and Japanese Patent Laid-Open No. 5-341132 disclose a film in which function of a light diffusion film and function of a lens film are integrated.

### DISCLOSURE OF THE INVENTION

However, in the above conventional configurations, stacking layers of films requires many steps, and not only the steps are complicated but also the cost increase is inevitable.

In addition, since the surface of flat lenses such as lenticular lenses and prism sheets are fragile and easily stained, they are generally delivered with a protective sheet being stacked on the surface.

However, such a protective sheet is merely discarded after it is removed from flat lenses, and the sheet undesirably not only wastes resources but also causes increase in the cost. In addition, operation of removing protective sheets from flat lenses is required, which then decreases productivity. Moreover, contaminants such as dust are easily attached to flat lenses upon removal of protective sheets from flat lenses due to electrostatic charge, causing problems of quality.

In addition, when stacking layers of films (sheets), scratches are easily generated due to friction upon stacking, friction from thermal expansion and thermal contraction and friction in handling.

In assembling steps of a backlight unit for a liquid crystal display panel and processing steps of punching or cutting the optical sheet used for the backlight unit into a predetermined shape, static eliminating air is sprayed by an ionizer, an aqueous solution containing an antistatic agent is applied or a coating film of an antistatic agent is formed by a spray or the like to prevent attachment of dust on the surface of sheets.

However, since the method using static eliminating air is merely temporary prevention of static charge in assembling line or processing steps, there is no anti-static effect upon use (assembling) after long time, for example, after delivered to assembling factories. Further, optical sheets for a display on which a coating film of an antistatic agent is formed lack uniformity in optical properties and have a problem that adhesion strength is decreased due to the antistatic agent applied to the surface in the secondary processing of combining a diffusion sheet and a prism sheet by bonding.

In addition, while produced optical sheets for a display are packaged with a packaging material so that they are not damaged, packaging optical sheets one by one involves a lot of effort and the cost inevitably increases.

Moreover, such packaging materials are merely discarded after they are removed from the sheet, and the materials undesirably not only waste resources but also cause increase in the cost. In addition, operation of removing packaging materials from a film is required, which then decreases productivity. Further, due to friction occurring during transportation, scratches are easily formed on the film.

The present invention has been made in view of such circumstances and aims at providing an optical sheet for a display and a method for producing the same suitable for producing a high quality laminate of sheet-shaped materials used for displays such as liquid crystal display devices in a simple method without decrease in the adhesion strength between the sheet-shaped materials.

The present invention also aims at providing a package of an optical sheet for a display and a method for packaging the optical sheet for a display, in which sheet-shaped materials used for displays such as liquid crystal display devices are easily packaged at a lower cost compared to conventional arts.

A first aspect of the present invention provides an optical sheet for a display comprising two or more optical sheets which are stacked and bonded at one or more parts, wherein a coating film containing a water-soluble antistatic agent and a fluorine surfactant is formed on at least one side of each bonding surface of the two or more optical sheets in a thickness of 0.03 to 0.2 g/m².

Optical sheets as herein described generally refer to various sheets having optical function. The sheets typically include diffusion sheets, polarizing plates (diffusion sheet film) and various lens sheets (including lenticular lenses, fly-eye lenses and prism sheets), and protective sheets (protective films) which have little optical function are also included.

According to this invention, since a coating film containing a water-soluble antistatic agent and a fluorine surfactant is formed on at least one side of each bonding surface of the optical sheets in a thickness of 0.03 to 0.2 g/m², anti-static effects are given to the optical sheets. Further, in the secondary processing in which two or more optical sheets are combined by bonding, the bonded surface is not separated in usual handling. In other words, the present inventors have found that a coating film containing not only a water-soluble antistatic agent but also a fluorine surfactant produces anti-static effects, and also prevents decrease in the adhesion strength caused by the antistatic agent and improves adhesiveness. In short, the fluorine surfactant produces wettability and thus prevents decrease in adherability of films due to the antistatic agent without damaging anti-static effects. Herein, the thickness of the coating film is set at 0.03 to 0.2 g/m², because not only anti-static effects but also wettability cannot be obtained when the coating film is thinner than 0.03 g/m², and also because optical properties and appearance are affected by visible light when the coating film is thicker than 0.2 g/m².

Accordingly, the optical sheet for a display of the present invention has excellent anti-static properties and excellent adhesiveness for a long time. In addition, since the film thickness is less than the wavelength of visual light, transparency of a transparent resin which is a substrate is not damaged at all, and surface appearance is just the same as that of non-treated products. Further, the optical sheet of the present invention has good anti-fogging properties to significantly improve fogging inside a backlight unit due to temperature change, and also has an effect of improving scratch resistance. As a result, attachment of dust in handling optical sheets is reduced in not only processing steps but also assembling steps of backlights, and thus the quality of products is improved.

A second aspect of the present invention provides an optical sheet for a display comprising a lens sheet in which convex lenses are formed adjacent to each other in an axial direction almost on the whole area and a light diffusion sheet stacked on a surface and/or a backside of at least one lens sheet, wherein the lens sheet and the light diffusion sheet are bonded at one or more parts, and a coating film containing a water-soluble antistatic agent and a fluorine surfactant is formed on at least one side of each bonding surface of the lens sheet and the light diffusion sheet in a thickness of 0.03 to 0.2 g/m².

A third aspect of the present invention provides an optical sheet for a display comprising two lens sheets which are stacked and in which convex lenses are formed adjacent to each other in an axial direction almost on the whole area and a light diffusion sheet stacked on a surface and/or a backside of a laminate of the lens sheets, wherein the lens sheets themselves and the lens sheets and the light diffusion sheet are bonded at one or more parts, and a coating film containing a water-soluble antistatic agent and a fluorine surfactant is formed on at least one side of each bonding surface of the lens sheets themselves and the lens sheets and the light diffusion sheet in a thickness of 0.03 to 0.2 g/m.

These inventions describe a light diffusion sheet and a lens sheet as the optical sheet in the invention of the optical sheet for a display of the first aspect.

The “lens sheets” typically include lenticular lenses and prism sheets, and also diffraction gratings.

In a fourth aspect of the present invention, the water-soluble antistatic agent is a cationic antistatic agent in the invention of the first to the third aspects.

For preventing static charge in an optical sheet, sufficient anti-static effects can be produced even in a thin film thickness when the water-soluble antistatic agent is a cationic antistatic agent.

A fifth aspect of the present invention provides a method for producing an optical sheet for a display, comprising the steps of: forming a coating film of an aqueous solution containing a water-soluble antistatic agent and a fluorine surfactant on at least one side of each bonding surface of two or more optical sheets whose plane size is equal to or larger than a product size in a thickness after drying of 0.03 to 0.2 g/m²; stacking the two or more optical sheets whose plane size is equal to or larger than a product size; joining the two or more optical sheets at one or more parts; and cutting a laminate of the two or more optical sheets into the product size.

According to this invention, two or more optical sheets whose plane size is equal to or larger than a product size are stacked, the laminate is cut into the product size, and the optical sheets are joined at one or more parts thereof.

As a result, steps of cutting a number of films (sheets) each into a product size can be omitted, and also steps of stacking layers of films (sheets) with determining positions can be omitted. Further, the above problem with protective sheets does not arise, which is advantageous in view of both the cost and the quality.

Moreover, since an aqueous solution containing a water-soluble antistatic agent and a fluorine surfactant is applied in a thickness after drying of 0.03 to 0.2 g/m² in the step of coating, adhesiveness of films is improved.

As described above, this invention can provide a method for producing an optical sheet for a display suitable for producing a high quality optical sheet in a simple method without decrease in the adhesion strength between sheet-shaped materials.

The phrase “plane size is equal to or larger than a product size” means that not only lens sheets or diffusion sheets whose plane size is larger than a product size are included, but also lens sheets or diffusion sheets whose plane size is equal to the product size are included. In the latter case, one or more sides of a lens sheet or a diffusion sheet may not be cut in the step of cutting.

A sixth aspect of the present invention provides a method for producing an optical sheet for a display, comprising the steps of: forming a coating film of an aqueous solution containing a water-soluble antistatic agent and a fluorine surfactant on at least one side of each bonding surface of a lens sheet in which convex lenses are formed adjacent to each other in an axial direction almost on the whole area and whose plane size is equal to or larger than a product size and a light diffusion sheet whose plane size is equal to or larger than a product size in a thickness after drying of 0.03 to 0.2 g/m²; stacking the light diffusion sheet on a surface and/or a backside of at least one lens sheet; joining the lens sheet and the light diffusion sheet at one or more parts; and cutting a laminate of the light diffusion sheet and the lens sheet into the product size.

A seventh aspect of the present invention provides a method for producing an optical, sheet for a display, comprising the steps of: forming a coating film of an aqueous solution containing a water-soluble antistatic agent and a fluorine-surfactant on at least one side of each bonding surface of a lens sheet in which convex lenses are formed adjacent to each other in an axial direction almost on the whole area and whose plane size is equal to or larger than a product size and a light diffusion sheet whose plane size is equal to, or larger than the product size in a thickness after drying of 0.03 to 0.2 g/m²; stacking two of the lens sheet and stacking the light diffusion sheet on a surface and/or a backside of a laminate of the lens sheets; joining the lens sheets themselves and the lens sheets and the light diffusion sheet at one or more parts; and cutting periphery of a laminate of the light diffusion sheet and the lens sheets into the product size.

These inventions describe a light diffusion sheet and a lens sheet as the optical sheet in the invention of the method for producing an optical sheet for a display of the fifth aspect.

In an eighth aspect, coating in the step of forming the coating film is performed by an aerosol spraying method in the fifth to seventh aspects.

The aerosol spraying method provides excellent wetting properties on the surface of optical sheets such as light diffusion sheets and prism sheets. Since particles spread into a uniform thin film without agglomeration, an extremely thin and uniform coating film can be easily formed even on optical sheets of various surface shapes only by subjecting to aerosol spraying.

A package of an optical sheet for a display according to a ninth aspect of the present invention comprises a laminate of a product size in which two or more kinds of optical sheets are stacked in a predetermined order and which is packaged in a packaging material, wherein the packaging material is sealed by reducing pressure with the packaging material being brought into close contact with the laminate.

According to this invention, a packaging material is sealed with a laminate of plural kinds of optical sheets stacked in a predetermined order being brought into close contact with the packaging material. Accordingly, damage on the object to be packaged (laminate) can be prevented, and the number of operations upon assembling the laminate of optical sheets can be reduced, contributing to cost reduction.

Specifically, steps of cutting a number of films (sheets) each into a product size can be omitted, and also steps of stacking layers of films (sheets) with determining positions can be omitted. Further, damages on an object to be packaged can be prevented without using protective sheets and thus problems with protective sheets do not arise, which is advantageous in view of both the cost and the quality. Moreover, problems with stacking layers of films or thermal expansion or thermal shrinkage of films are not caused.

The “optical sheet” as herein described means the same as above.

For the “laminate of a product size”, an aspect in which optical sheets larger than a product size are stacked and then cut into a product size is preferred.

When packaging a laminate with a packaging material (temporary packaging), preferably the laminate is transferred with one or more parts thereof being clipped.

A preferred aspect of “packaging materials” is one in which one side end (end) of a packaging material has an opening through which an object to be packaged (laminate) is inserted into the bag-shaped packaging material.

When “the packaging material is sealed by reducing pressure”, an aspect in which a packaging material in which a laminate is packaged is brought into a vacuum condition at a predetermined degree of vacuum is preferred.

A package of an optical sheet for a display according to a tenth aspect of the present invention comprises a laminate of a product size in which two or more kinds of optical sheets are stacked in a predetermined order and periphery of the optical sheets is joined at one or more parts and which is packaged in a packaging material, wherein the packaging material is sealed by reducing pressure with the packaging material being brought into close contact with the laminate.

According to this invention, since the periphery of a laminate is joined at one or more parts, damage due to friction between optical sheets constituting the laminate during transport of the laminate can be prevented. An aspect of joining four sides of the laminate is more preferred. When four sides of the periphery of a laminate are joined, the laminate is more firmly fixed, and mixing of contaminants such as dust can be more effectively prevented.

For joining optical sheets constituting a laminate, joining members such as adhesive or double-sided adhesive tape may be used, or joining by welding may be applied. Heating with ultrasonic wave or heating by irradiation of laser beams can be used as a device for welding optical sheets constituting a laminate. In the aspect using welding, the step of cutting a laminate composed of optical sheets larger than a product size into a product size and the step of joining the optical sheets constituting the laminate can be integrated.

The invention described in an eleventh aspect relates to an aspect of the package of an optical sheet for a display according to the ninth or tenth aspect, and the optical sheets include a lens sheet and a diffusion sheet.

According to the invention described in the eleventh aspect, by combining a lens sheet which is fragile and easily contaminated and a diffusion sheet in which scratches are not noticeable (namely, using a diffusion sheet on at least one surface of a laminate), damage and contamination of the lens sheet can be prevented. An aspect of stacking a diffusion sheet on both sides of a lens sheet is more preferred.

The lens sheets include a “lens sheet in which convex lenses are formed adjacent to each other in an axial direction almost on the whole area”. The “lens sheet in which convex lenses are formed adjacent to each other in an axial direction almost on the whole area” is typically a lenticular lens or a prism sheet, and also diffraction gratings are included.

The invention described in a twelfth aspect relates to an aspect of the package of an optical sheet for a display according to the ninth to eleventh aspects, and the optical sheets include a stacked lens sheet in which a plurality of lens sheets are stacked and a diffusion sheet.

Aspects of stacked lens sheets in which a plurality of lens sheets are stacked include an aspect in which sheets are stacked so that the axis of each lens sheet is substantially at right angles and an aspect in which the angle is slightly adjusted to prevent moire stripes.

The invention described in a thirteenth aspect relates to an aspect of the package of an optical sheet for a display according to any one of the ninth to twelfth aspects, and the optical sheets in the laminate are stacked in an order to be installed in a backlight unit.

By stacking optical sheets in an order to be installed in a backlight unit (BLU), assembling steps of BLU can be simplified.

The invention described in a fourteenth aspect relates to the package of an optical sheet for a display according to any one of the ninth to thirteenth aspects, and the packaging material has a predetermined elasticity at least at a portion where the member comes into contact with the laminate.

The invention described in the fourteenth aspect ensures close contact between the packaging material and the laminate and thus can prevent scratches due to friction between the packaging material and the laminate and generation of dust. Furthermore, in an aspect using a heat-shrinkable resin film for the packaging material, close contact and air tightness between the packaging material and the laminate can be further improved by employing shrink packaging together.

To achieve the above object, the method for packaging an optical sheet for a display according to a fifteenth aspect of the present invention comprising the steps of: temporarily packaging a laminate of a product size in which two or more kinds of optical sheets are stacked in a predetermined order in a packaging material; reducing the pressure in the packaging material so that the packaging material is brought into close contact with the laminate; and sealing the packaging material with the packaging material being brought into close contact with the laminate

An aspect using an optical sheet larger than a product size includes a cutting step of cutting a laminate composed of optical sheets larger than a product size into a product size.

When a heat-shrinkable material is used as a packaging material, preferably the pressure reduction step (or the sealing step) includes a heating step of heating a packaging material in which a laminate is temporarily packaged.

The method for packaging an optical sheet for a display according to a sixteenth aspect of the present invention comprising the steps of: joining a laminate of a product size in which two or more kinds of optical sheets are stacked in a predetermined order at one or more parts of the periphery of the optical sheets; temporarily packaging the laminate whose periphery is joined at one or more parts in the step of joining in a packaging material; reducing the pressure in the packaging material so that the packaging material is brought into close contact with the laminate; and sealing the packaging material with the packaging material being brought into close contact with the laminate.

In an aspect in which at least one part of the laminate is bonded, displacement of optical sheets or friction of sheets due to such displacement can be prevented upon packaging (particularly upon handling).

As described above, according to the optical sheet for a display and the method for producing the same of the present invention, a high quality optical sheet for a display and a method for producing the same suitable for producing such an optical sheet in a simple method without decrease in the adhesion strength upon bonding optical sheets can be provided.

Further, according to the package of an optical sheet for a display of the present invention and a method for packaging the optical sheet for a display, an object to be packaged (a laminate composed of plural kinds of optical sheets) can be packaged in close contact with a packaging material, and damage on the object to be packaged can be prevented. In addition, the number of operations for incorporating members necessary for assembling a backlight is reduced, contributing to reduction of production cost.

### BRIEF DESCRIPTION OF THE DRAWINGS

FIG. 1 illustrates a cross-sectional structure of an optical sheet for a display of the first embodiment;

FIG. 2 illustrates a cross-sectional structure of an optical sheet for a display of the second embodiment;

FIG. 3 illustrates a cross-sectional structure of an optical sheet for a display of the third embodiment;

FIG. 4 illustrates a cross-sectional structure of an optical sheet for a display of the fourth embodiment;

FIG. 5 illustrates a cross-sectional structure of an optical sheet for a display of the fifth embodiment;

FIG. 6 illustrates a cross-sectional structure of an optical sheet for a display of the sixth embodiment;

FIG. 7 is a schematic view of line for producing an optical sheet for a display applied to the first method;

FIG. 8 is a schematic view of line for producing an optical sheet for a display applied to the second method;

FIG. 9 is a schematic view of line for producing an optical sheet for a display applied to the third method;

FIG. 10 is a schematic view of line for producing an optical sheet for a display applied to the fourth method;

FIG. 11 is a schematic view of line for producing an optical sheet for a display applied to the fifth method;

FIG. 12 is a schematic view of line for producing an optical sheet for a display applied to the sixth method;

FIG. 13A illustrates arrangement of sheets on a plane, which are to be punched out from a laminate in the first method;

FIG. 13B illustrates arrangement of sheets on a plane, which are to be punched out from a laminate in the first method;

FIG. 14A illustrates arrangement of sheets on a plane, which are to be punched out from a laminate in the second to sixth methods;

FIG. 14B illustrates arrangement of sheets on a plane, which are to be punched out from a laminate in the second to sixth methods;

FIG. 15 is a table showing the composition of a resin solution used for preparing a prism sheet;

FIG. 16 is a schematic view of an apparatus for producing a prism sheet;

FIG. 17A illustrates a method for packaging the optical sheet for a display shown in FIG. 1 to FIG. 6;

FIG. 17B illustrates a method for packaging the optical sheet for a display shown in FIG. 1 to FIG. 6;

FIG. 17C illustrates a method for packaging the optical sheet for a display shown in FIG. 1 to FIG. 6; and

FIG. 17D illustrates a method for packaging the optical sheet for a display shown in FIG. 1 to FIG. 6.

### DESCRIPTION OF SYMBOLS

10 . . . optical sheet for display, 11 . . . line for producing optical sheet for display, 12 . . . first diffusion sheet, 12B . . . roll, 14 . . . first prism sheet, 16 . . . second prism sheet, 18 . . . second diffusion sheet, 20 . . . optical sheet for display, 20 . . . solid concentration, 21 . . . line for producing optical sheet for display, 24 . . . laser head, 26 . . . conveyor, 28 . . . suction-type lateral transfer device, 30 . . . optical sheet for display, 31 . . . line for producing optical sheet for display, 32 . . . stacking device, 34 . . . laminate, 36 . . . roll, 40 . . . optical sheet for display, 41 . . . line for producing optical sheet for display, 42 . . . dispenser, 44 . . . dispenser, 46 . . . dispenser, 48 . . . pressing device, 50 . . . melting point, 51 . . . line for producing optical sheet for display, 52 . . . tape feeder, 54 . . . tape feeder, 56 . . . tape feeder, 60 . . . optical sheet for display, 61 . . . line for producing optical sheet for display, 62 . . . ultrasonic horn, 64 . . . ultrasonic horn, 66 . . . ultrasonic horn, 72 . . . laser head, 74 . . . laser head, 76 . . . laser head, 78 . . . laser head, 82 . . . coating device, 82B . . . feeder, 82C . . . coating head 83 . . . emboss roller, 84 . . . nip roller, 85 . . . device for curing resin, G . . . guide roller, P . . . device for forming coating film (aerosol spraying device), 100 . . . bundle, 104 . . . packaging material, 108 . . . air suction nozzle, 110 . . . heat seal mechanism

### BEST MODE FOR CARRYING OUT THE INVENTION

In the following, embodiments of the present invention are described with reference to the attached figures.

### [Optical Sheet for Display]

First, configurations of examples of optical sheets for a display produced by the method for producing an optical sheet for a display of the present invention (first to sixth embodiments) are described. Then, the methods for producing an optical sheet for a display are described.

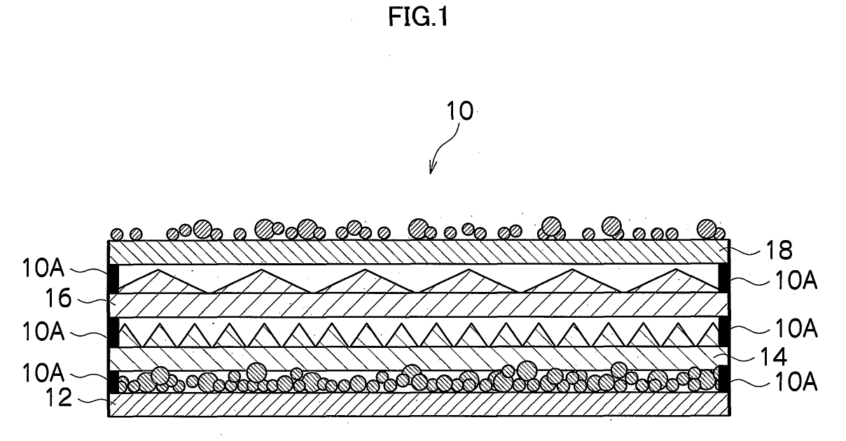

FIG. 1 is a cross-sectional view illustrating a configuration of an example of an optical sheet for a display produced by the method for producing an optical sheet for a display according to the present invention (a first embodiment).

The optical sheet for a display 10 is a module of optical sheets in which a first diffusion sheet 12, a first prism sheet 14, a second prism sheet 16 and a second diffusion sheet 18 are stacked from the bottom.

The first diffusion sheet 12 and the second diffusion sheet 18 are a sheet in which beads are fixed to the surface (one side) of a transparent film (support) by a binder and which has certain light diffusing ability. The beads on the first diffusion sheet 12 and that on the second diffusion sheet 18 have a different diameter (average particle size). Also, each sheet has different light diffusion ability.

A resin film can be used as the transparent film (support) used for the first diffusion sheet 12 and the second diffusion sheet 18. Known materials such as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), biaxially oriented polyethylene terephthalate, polyethylene naphthalate, polyamideimide, polyimide, aromatic polyamide, cellulose acylate, cellulose triacetate, cellulose acetate propionate and cellulose diacetate can be used as a material of the resin film. Of these, polyester, cellulose acylate acryl, polycarbonate and polyolefin are particularly preferably used.

The beads on the first diffusion sheet 12 and the second diffusion sheet 18 must have a diameter of 100 μm or less, preferably 25 μm or less. For example, beads may have an average particle size of 17 μm in a given distribution range of 7 to 38 μm.

The first prism sheet 14 and the second prism sheet 16 are a lens sheet in which convex lenses formed in one axial direction are disposed adjacent to each other almost on the whole sheet, for example, at a pitch of 50 μm, an irregularity height of 25 μm and an apex angle of the convex part of 90 degrees (right angle).

The first prism sheet 14 and the second prism sheet 16 are disposed so that the axis of the convex lens (prism) is substantially perpendicular to each other. Specifically, in FIG. 1, the axis of the convex lens of the first prism sheet 14 is disposed in the direction perpendicular to the sheet plane, while the axis of the convex lens of the second prism sheet 16 is disposed in the direction parallel to the sheet plane. In FIG. 1, to be able to see that the section of the second prism sheet 16 is convex, the section is shown in a direction different from the actual direction.

Various known aspects can be applied to the material of the first prism sheet 14 and the second prism sheet 16 and the method of producing them. For example, a method of producing a resin sheet may be used, in which a sheet-shaped resin material extruded through a die is pressed between a transfer roller (having a pattern opposite to that of a prism sheet on the surface) rotating at substantially the same rate as the extrusion rate of the resin material and a nip roller board positioned against the transfer roller and rotating at the same rate, thereby transferring irregularity patterns on the surface of the transfer roller to the resin.

Also, a method of producing a resin sheet in which a transfer plate (stamper) having a pattern opposite to that of a prism sheet on the surface and a resin plate are stacked and press-molding is performed by a hot press by heat transfer may be used.

Resin materials which can be used in such methods include thermoplastic resins such as polymethyl methacrylate resins (PMMA), polycarbonate resins, polystyrene resins, MS resins, AS resins, polypropylene resins, polyethylene resins, polyethylene terephthalate resins, polyvinyl chloride resins (PVC), thermoplastic elastomers, copolymers thereof and cycloolefin polymers.

For another method, a method of producing a resin sheet in which irregularities on the surface of an embossed roller (having a pattern opposite to that of a prism sheet on the surface) are transferred to a transparent film which is similar to those used for the first diffusion sheet 12 and the second diffusion sheet 18 (polyester, cellulose acylate, acryl, polycarbonate, polyolefin, etc.) may be used.

More specifically, a method of producing an embossed sheet may be used, in which a transparent film in which two or more layers of an adhesive layer and a resin layer (e.g., UV curable resin) are formed by sequentially applying an adhesive and a resin is continuously transferred, and the transparent film is put over the rotating embossed roller, thereby transferring irregularities on the surface of the embossed roller to the resin layer, and the resin layer is cured with the transparent film being put over the embossed roller (for example, by irradiating with UV). The adhesive may not be used.

The method of producing the first prism sheet 14 and the second prism sheet 16 is not limited to the above examples, and other methods may be used as long as desired irregularity patterns can be formed on the surface.

As shown in FIG. 1, a joining part 10A combines layers at the left and the right ends of the optical sheet for a display 10. The sheets are bonded by the joining part 10A by applying adhesive, for example, on the top surface of each sheet (the first diffusion sheet 12, the first prism sheet 14, and the second prism sheet 16).

The optical sheet for a display 10 described above is disposed, for example, between a light source device and a liquid crystal cell, and used to constitute a whole liquid crystal display device. This produces an advantage that assembling of liquid crystal display devices is very easy in addition to various advantages already described (being able to produce optical sheets for a display through steps simpler than those in conventional arts at low cost with high quality).

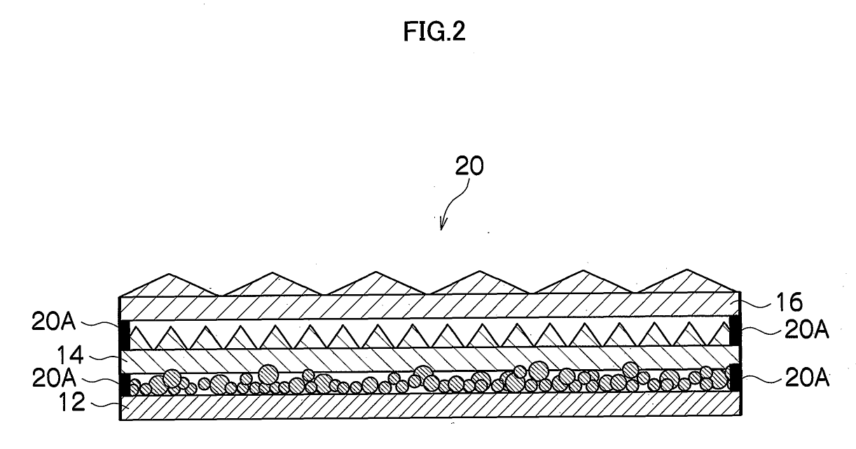

Next, another example (a second embodiment) of an optical sheet for a display produced by the method for producing an optical sheet for a display according to the present invention is described. FIG. 2 is a cross-sectional view illustrating a configuration of an optical sheet for a display 20. The same reference numerals are used for members which are the same as or similar to those in FIG. 1 (the first embodiment), and detailed description thereof is omitted.

The optical sheet for a display 20 is composed of a diffusion sheet 12, a first prism sheet 14 and a second prism sheet 16 which are stacked from the bottom. The second diffusion sheet 18 is omitted because diffusibility as wide as that in the above-described optical sheet for a display 10 is not required.

As shown in FIG. 2, a joining part 20A combines layers at the left and the right ends of the optical sheet for a display 20. The joining method is substantially the same as that in the first embodiment.

The optical sheet for a display 20 described above is disposed, for example, between a light source device and a liquid crystal cell, and used to constitute a whole liquid crystal display device as in the first embodiment.

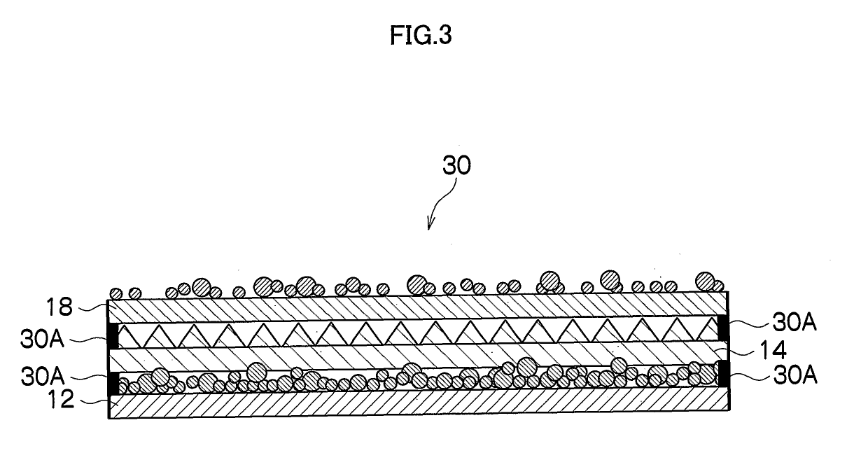

Next, still another example (a third embodiment) of an optical sheet for a display produced by the method for producing an optical sheet for a display according to the present invention is described. FIG. 3 is a cross-sectional view illustrating a configuration of an optical sheet for a display 30. The same reference numerals are used for members which are the same as or similar to those in FIG. 1 (the first embodiment) and FIG. 2 (the second embodiment), and detailed description thereof is omitted.

The optical sheet for a display 30 is composed of a first diffusion sheet 12, a prism sheet 14 and a second diffusion sheet 18 which are stacked from the bottom.

In the optical sheet for a display 30, the second prism sheet 16 is omitted because diffusibility in the direction perpendicular to the sheet plane as in the above-described optical sheet for a display 10 is not required.

As shown in FIG. 3, a joining part 30A combines layers at the left and the right ends of the optical sheet for a display 30. The joining method is substantially the same as that in the first embodiment.

The optical sheet for a display 30 described above is disposed, for example, between a light source device and a liquid crystal cell, and used to constitute a whole liquid crystal display device as in the first embodiment.

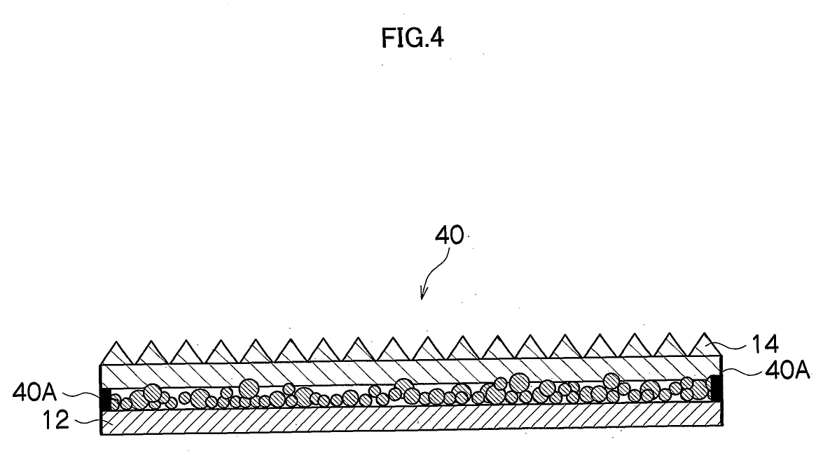

Next, still another example (a fourth embodiment) of an optical sheet for a display produced by the method for producing an optical sheet for a display according to the present invention is described. FIG. 4 is a cross-sectional view illustrating a configuration of an optical sheet for a display 40. The same reference numerals are used for members which are the same as or similar to those in FIG. 1 (the first embodiment) and FIG. 2 (the second embodiment), and detailed description thereof is omitted.

The optical sheet for a display 40 is composed of a diffusion sheet 12 and a prism sheet 14 which are stacked from the bottom. The second diffusion sheet 18 is omitted because diffusibility as wide as that in the optical sheet for a display 10 is not required. The second prism sheet 16 is omitted because diffusibility in the direction perpendicular to the sheet plane as in the optical sheet for a display 10 is not required.

As shown in FIG. 4, a joining part 40A combines layers at the left and the right ends of the optical sheet for a display 40. The joining method is substantially the same as that in the first embodiment.

The optical sheet for a display 40 described above is disposed, for example, between a light source device and a liquid crystal cell, and used to constitute a whole, liquid crystal display device as in the first embodiment.

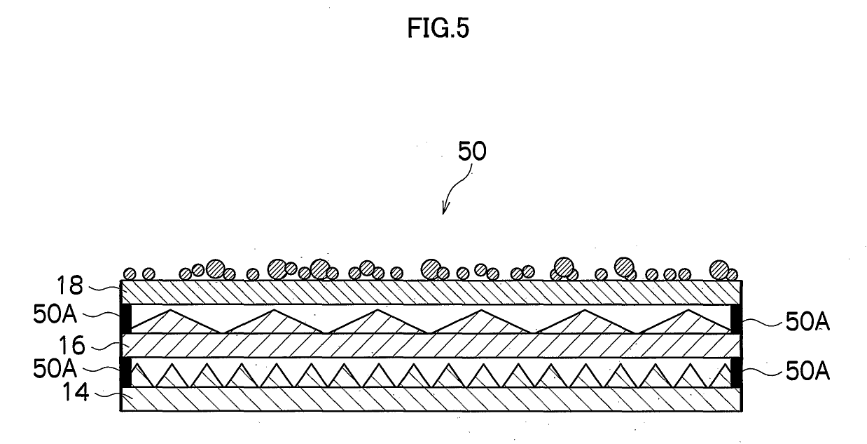

Next, still another example (a fifth embodiment) of an optical sheet for a display produced by the method for producing an optical sheet for a display according to the present invention is described. FIG. 5 is a cross-sectional view illustrating a configuration of an optical sheet for a display 50. The same reference numerals are used for members which are the same as or similar to those in FIG. 1 (the first embodiment) and FIG. 2 (the second embodiment), and detailed description thereof is omitted. The optical sheet for a display 50 is composed of a first prism sheet 14, a second prism sheet 16 and a diffusion sheet 18 which are stacked from the bottom. The first diffusion sheet 12 is omitted because diffusibility as wide as that in the above-described optical sheet for a display 10 is not required.

As shown FIG. 5, a joining part 50A combines layers at the left and the right ends of the optical sheet for a display 50. The joining method is substantially the same as that in the first embodiment.

The optical sheet for a display 50 described above is disposed, for example, between a light source device and a liquid crystal cell, and used to constitute a whole liquid crystal display device as in the first embodiment.

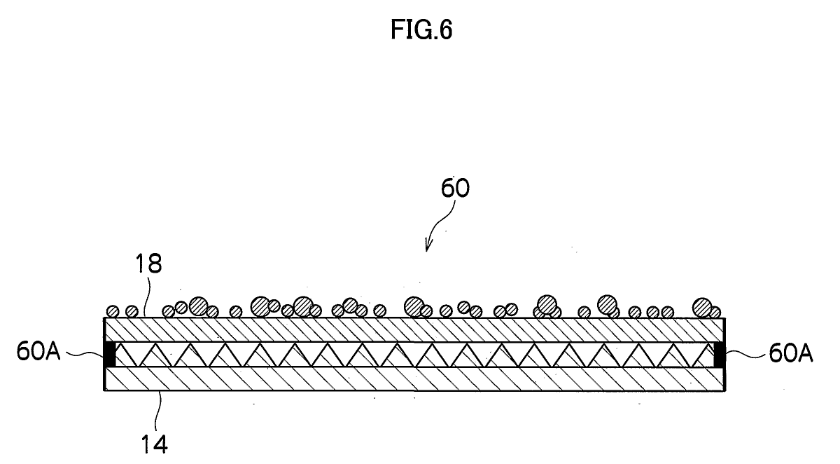

Next, still another example (a sixth embodiment) of an optical sheet for a display produced by: the method for producing an optical sheet for a display according to the present invention is described. FIG. 6 is a cross-sectional view illustrating a configuration of an optical sheet for a display 60. The same reference numerals are used for members which are the same as or similar to those in FIG. 1 (the first embodiment) and FIG. 2 (the second embodiment), and detailed description thereof is omitted. The optical sheet for a display 60 is composed of a first prism sheet 14 and a diffusion sheet 18 which are stacked from the bottom. The first diffusion sheet 12 is omitted because diffusibility as wide as that in the above-described optical sheet for a display 10 is not required. The second prism sheet 16 is omitted because diffusibility in the direction perpendicular to the sheet plane as in the above-described optical sheet for a display 10 is not required.

As shown FIG. 6, a joining part 60A combines layers at the left and the right ends of the optical sheet for a display 60. The joining method is substantially the same as that in the first embodiment.

The optical sheet for a display 60 described above is disposed, for example, between a light source device and a liquid crystal cell, and used to constitute a whole liquid crystal display device as in the first embodiment.

### [Method for Producing Optical Sheet for Display]

The methods for producing an optical sheet for a display (first to sixth methods) are now described. These methods can be commonly applied to the optical sheets for a display 10 to 60 described earlier, but for illustrative purposes, a method applied to production of an optical sheet for a display of a four-layer structure (the first embodiment) is described.

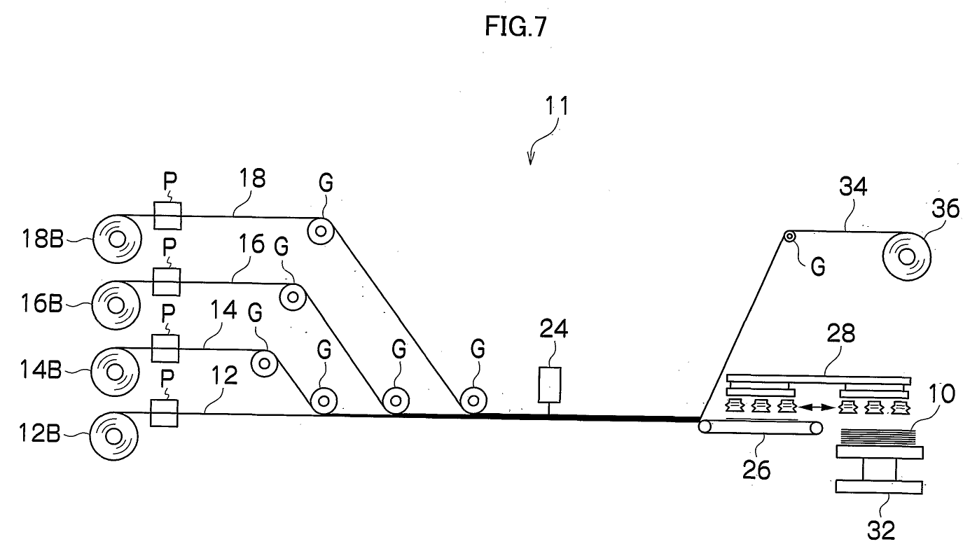

FIG. 7 is a schematic view of production line for an optical sheet for a display 11 applied to the first method. The first diffusion sheet 12, the first prism sheet 14, the second prism sheet 16 and the second diffusion sheet 18 shown in FIG. 1 described earlier are each wound around rolls 12B, 14B, 16B and 18B disposed at the left end of the figure.

The rolls 12B, 14B, 16B and 18B are each held by the rotational axis of a feeding device which is not shown. The first diffusion sheet 12, the first prism sheet 14, the second prism sheet 16 and the second diffusion sheet 18 can be fed from the rolls 12B, 14B, 16B and 18B at about the same rate.

A coating film composed of a water-soluble antistatic agent and a fluorine surfactant is formed on each of the first diffusion sheet 12, the first prism sheet 14, the second prism sheet 16 and the second diffusion sheet 18 that have been fed using device for forming a coating film P, P . . . described later (coating film forming step), and with being held by guide rollers G, G . . . , the sheets are finally stacked at the upstream of the laser head 24 described later (stacking step).

In the coating device P, a coating film composed of an water-soluble antistatic agent and a fluorine surfactant is formed on at least the surface of each of the first diffusion sheet 12, the first prism sheet 14, the second prism sheet 16 and the second diffusion sheet 18 in a thickness of 0.03 to 0.2 g/m².

The method of forming a coating film of an aqueous solution of a water-soluble antistatic agent and a fluorine surfactant on the light diffusion sheets 12,18 and the prism sheets 14, 16 is not particularly limited. Various methods such as an application method using a brush, a dipping method, a spraying method and an aerosol spraying method may be used. Of these, an aerosol spraying method, in particular, an aerosol spraying method in which mist is generated using an ultrasonic oscillator is most preferred because optical properties and appearance can be maintained. The aerosol spraying method provides excellent wetting properties on the surface of light diffusion sheets 12, 18 and the prism sheets 14, 16. Since particles spread into a thin film without agglomeration, an extremely thin and uniform coating film can be easily formed on both sides of the sheet substantially simultaneously even in the case of light diffusion sheets 12, 18 and prism sheets 14, 16 of various surface shapes only by subjecting them to aerosol spraying. A known aerosol spraying method is used as the aerosol spraying method.

The water-soluble antistatic agent to be used is a water-soluble antistatic agent generally used for preventing electrostatic charge of synthetic resin. Examples thereof include cationic antistatic agents such as lauryltrimethylammonium chloride, stearyltrimethylammonium chloride, lauryldiethanolamine and stearylamine hydrochloride, anionic antistatic agents such as diethanolamine alkylphosphate, potassium alkylphosphate and alkylbenzenesulfonate and nonionic antistatic agents such as polyoxyethylene glycol monooleate and polyethylene sorbitan monooleate. Of these, cationic antistatic agents are particularly preferably used. For preventing static charge in optical sheets such as light diffusion sheets and prism sheets, sufficient anti-static effects can be produced when the water-soluble antistatic agent is a cationic antistatic agent even if the coating film has a thin film thickness.

Examples of fluorine surfactants include fluoroalkyl carboxylates (alkali metal salts, alkaline earth metal salts, amine salts), perfluoroalkyl carboxylates, fluoroalkyl phosphate ester salts, perfluoroalkyl phosphate ester salts, polyoxyethylene perfluoroalkyl phosphate ester salts, perfluoroalkyl sulfate ester salts, polyoxyethylene perfluoroalkyl sulfate ester salts, perfluoroalkyl sulfonamide derivatives, perfluoroalkylamine salts, perfluoroalkyl quaternary ammonium salts, perfluoroalkylimidazolidine derivatives, perfluoroalkylbetaine, polyoxyethylene perfluoroalkylphenol, polyoxyethylene perfluoroalkylamine and perfluoroalkylcarboxylic acid sorbitan ester.

Specific examples of such surfactants include sodium 16-fluorohexadecyl carboxylate, perfluorooctylcarboxylic acid N,N-diethanolamine, sodium perfluorodecyl phosphate ester, sodium perfluorooctyl phosphate ester, polyoxyethylene sodium perfluorooctyl phosphate ester, N-polyoxyethylene-N-ethyl perfluorooctylsulfonamide, N,N-di(polyoxyethylene) perfluorooctylsulfonamide, N-polyoxyethylene-N-butyl perfluorodecylsulfonamide, N-polyoxyethylene-N-ethyl perfluorooctadecylsulfonamide, perfluorooctadecyl-N-ethyldimethylammonium salt, perfluorododecyltrimethylammonium salt, perfluorooctadecylbetaine, polyoxyethylene perfluorooctyl ether, polyoxyethylene perfluorooctadecenyl ether, polyoxyethylene perfluorohexylamine and perfluorododecyl carboxylic acid sorbitan ester. These may be used alone or in combination of two or more.

The film thickness of the coating film containing a water-soluble antistatic agent and a fluorine surfactant may be adjusted according to the concentration of the water-soluble antistatic agent and the fluorine surfactant in the aqueous solution or coating conditions such as treating time. By adjusting the thickness to 0.03 to 0.2 g/m² after drying, anti-static effects can be given to optical sheets such as diffusion sheets and prism sheets. Further, in the secondary processing in which optical sheets are combined by bonding described later, the bonded surface is not separated in usual handling. In other words, a coating film containing not only a water-soluble antistatic agent but also a fluorine surfactant produces anti-static effects, and also prevents decrease in the adhesion strength caused by the antistatic agent and improves adhesiveness. In short, the fluorine surfactant produces wettability and thus prevents decrease in adherability of films due to the antistatic agent without damaging anti-static effects. Herein, the thickness of the coating film is set at 0.03 to 0.2 g/m², because not only anti-static effects but also wettability cannot be obtained when the coating film is thinner than 0.03 g/m², and also because optical properties and appearance are affected by visible light when the coating film is thicker than 0.2 g/m².

Such a coating film is formed by forming a coating film of an aqueous solution containing a water-soluble antistatic agent and a fluorine surfactant using device for forming a coating film P, P . . . and then drying. Drying may be performed by a known method such as air drying at room temperature, allowing to stand under a predetermined temperature condition or spraying of warm air.

YAG laser irradiation apparatuses and semiconductor laser irradiation apparatuses with a wavelength of 355 to 1064 nm and carbon dioxide gas laser irradiation apparatuses with a wavelength of 9 to 11 μm can be used as a laser irradiation apparatus including the laser head 24. The mode of oscillation may be continuous oscillation or pulse oscillation, but when welding is almost simultaneously performed with cutting, spotting by pulse oscillation is preferred because appearance upon finish is good.

The output and the frequency required for performing cutting (cutting step) and welding (joining step) almost simultaneously vary depending on the feed rate of materials, the scanning rate of laser beams and the thickness of materials. Good welding results are obtained under conditions of an output of about 2 to 50 W and a frequency of about 100 kHz or lower.

The laser head 24 is attached to an X drive robot axis or an XY drive robot axis movable to the X direction (in the direction of the width of sheet) or the XY direction, and this makes it possible to determine positions or change tracks optionally. The entire laser head 24 may be moved depending on the irradiation pattern of laser beams, but the laser head 24 may be separately arranged (fixed) and only laser beams are guided by optical fiber to simplify the XY direction moving mechanism.

A known mechanism (aspirator, etc) which sucks in smoke generated upon cutting and welding by the laser head 24 may also be provided.

Periphery portions of a laminate which are to be cut and joined are irradiated with laser beams from the laser head 24 and with moving the irradiation spot at a constant rate, the periphery of the laminate is cut into a product size, melted and joined.

On the other hand, the sheet-shaped laminate 34 from which the optical sheet for a display 10 is punched out by the laser head 24 is taken up on a take-up roll 36 in a take-up device (details not shown).

The above first method for producing an optical sheet for a display provides the following advantages.

1) Advantage of Reducing Scratch Defect

When there are scratches on the upper surface and the lower surface of a lens sheet (a first prism sheet 14, a second prism sheet. 16), they are noticeable due to lens effect. On the other hand, when scratches are present on the lower surface of a diffusion, sheet (a first diffusion sheet 12, a second diffusion sheet 18), they are not noticeable because light is diffused. From these facts, prevention of scratches on the lens sheet leads to reduction of scratch defects. Scratches are often generated upon handling after processing into sheet. By combining a lens sheet and a diffusion sheet, the diffusion sheet serves as a protective sheet and therefore defects due to scratches can be reduced. This effect is particularly large in the optical sheet for a display 10 in the first embodiment (see FIG. 1) and the optical sheet for a display 30 in the second embodiment (see FIG. 3) in which the lens sheet is not exposed on the surface.

Further, by applying an aqueous solution containing a water-soluble antistatic agent and a fluorine surfactant, the coating film protects the surface of sheets, and the sheets have improved scratch resistance compared to those without such a coating film. As a result, defects due to scratches can be reduced.

2) Advantage of Reducing the Number of Assembling Steps

When, for example, an optical sheet for a display 10 (see FIG. 1) of the first embodiment is used in assembling a liquid crystal display device, the number of assembling steps is only one, which is to incorporate the optical sheet for a display 10; but when a conventional sheet is used, assembling involves 8 steps of incorporating a first diffusion sheet [symbol] removing the protective sheet on the back side of a first lens sheet [symbol] removing the protective sheet on the surface of the first lens sheet [symbol] incorporating the first lens sheet [symbol] removing the protective sheet on the back side of a second lens sheet [symbol] removing the protective sheet on the surface of the second lens sheet [symbol] incorporating the second lens sheet [symbol] incorporating a second diffusion sheet. As described above, according to the first production method, assembling steps can be significantly reduced and thus the product cost can be reduced.

3) Advantage of Saving on Protective Sheet

A protective sheet is often put on both sides of a lens sheet for prevention of scratches. The protective sheet is discarded after the lens sheet is assembled and so is very wasteful. In the present embodiment, the diffusion sheet serves as a protective sheet and thus helps to save on the protective sheets.

Specifically, one protective sheet can be reduced in the optical sheet for a display 40 of the fourth embodiment (see FIG. 4) and the optical sheet for a display 60 of the sixth embodiment (see FIG. 6); two protective sheets can be reduced in the optical sheet for a display 30 of the third embodiment (see FIG. 3); three protective sheets can be reduced in the optical sheet for a display 20 of the second embodiment (see FIG. 2) and the optical sheet for a display 50 of the fifth embodiment (see FIG. 5); and four protective sheets can be reduced in the optical sheet for a display 10 of the first embodiment (see FIG. 1).

4) Advantage of Preventing Attachment of Dust

Surfaces of optical films such as lens sheets and diffusion sheets are easily electrostatically charged in processing steps, and so dust is easily attached thereto. Since such attachment of dust can be prevented, a high quality optical sheet for a display in which no dust is included can be obtained.

5) Advantage of Improving Adhesiveness

A coating layer containing a fluorine surfactant prevents separation of bonded surfaces in usual handling during the secondary processing of combining optical sheets such as diffusion sheets and prism sheets by bonding. This leads to cut down of time spent for dealing with separation of optical sheets for a display upon handling after processing.

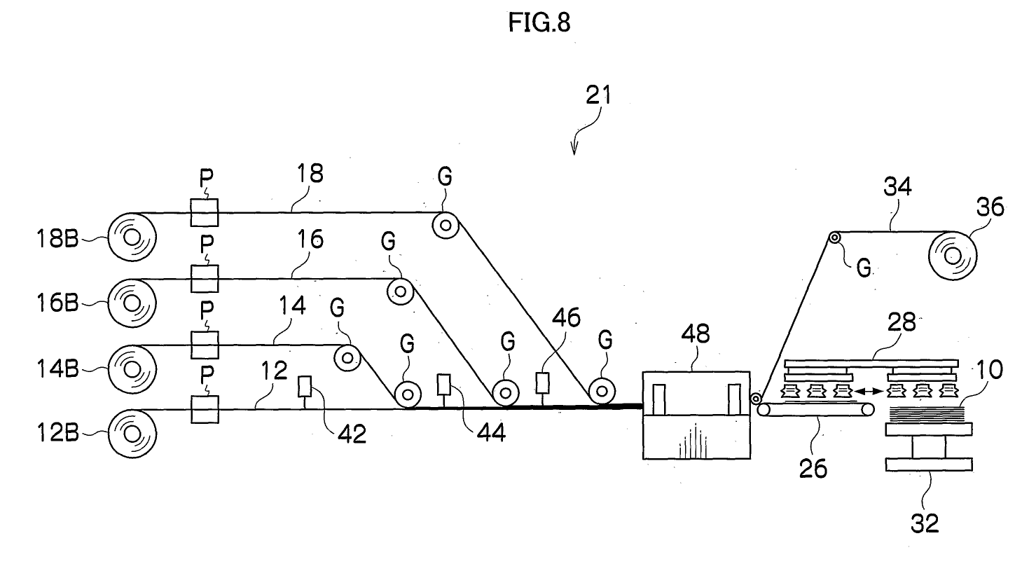

A second method for producing an optical sheet for a display is now described. FIG. 8 is a schematic view of production line for an optical sheet for a display 21 applied to the second method. The same reference numerals are used for members which are the same as or similar to those in the production line for an optical sheet for a display 11 of the first method (see FIG. 7), and detailed description thereof is omitted.

In the production line for an optical sheet for a display 21, dispensers 42, 44, 46 and a punching press device 48 are employed instead of the laser head 24 in the production line for an optical sheet for a display 11.

The dispensers 42, 44, 46 each are a feeder which discharges adhesive from the tip. The dispenser 42 supplies adhesive to the first diffusion sheet 12 to bond the first diffusion sheet 12 and the first prism sheet 14. The dispenser 44 supplies adhesive to the first prism sheet 14 to bond the first prism sheet 14 and the second prism sheet 16. The dispenser 46 supplies adhesive to the second prism sheet 16 to bond the second prism sheet 16 and the second diffusion sheet 18.

Preferably, the adhesive supplied from the dispensers 42, 44, 46 bonds sheets with the aid of heat or a catalyst. Specifically, general adhesives such as silicon adhesives, polyurethane adhesives, polyester adhesives, epoxy adhesives, cyanoacrylate adhesives and acrylic adhesives can be used.

Since optical sheets for a display 10 to 60 may be used at high temperatures, adhesives stable at room temperature to 120° C. are preferred. Of the above adhesives, epoxy adhesives have excellent strength and heat resistance, and therefore are preferably used. Cyanoacrylate adhesives have excellent immediate effects and strength, and therefore are applicable to efficient preparation of optical sheets for a display. Polyester adhesives are particularly preferred because they have excellent strength and processability.

These adhesives are roughly classified into thermosetting adhesives, hot melt adhesives and two-component adhesives according to bonding methods. Preferably, thermosetting adhesives or hot melt adhesives which enable continuous production are used. Preferably, the adhesive is applied in a coating thickness of 0.5 Ξm to 50 μm regardless of which adhesive is used.

A drying device for drying adhesive is preferably provided before press rollers G (guide rollers G) at the downstream. The drying device is not particularly limited, and examples thereof include known drying methods such as drying with warm air or hot air and drying with dehumidified air.

The dispensers 42, 44, 46 are attached to an X drive robot axis or an XY drive robot axis movable to the X direction (in the direction of the width of sheet) or the XY direction, and this makes it possible to determine positions or change tracks optionally.

The dispensers 42, 44, 46 supply adhesive to the periphery portions of a laminate which are to be joined, and with transferring the laminate, the periphery of the laminate is joined by press rollers (guide rollers G) at the downstream.

A punching press device 48 at the downstream of the dispensers 42, 44, 46 cuts the periphery of the laminate into product size. In the punching press device 48, the blade pierces through the center of the bonded portion, and thus composite sheets, which are punched sheets (optical sheets for a display 10 to 60) all or some of which are bonded only at the edges, can be obtained.

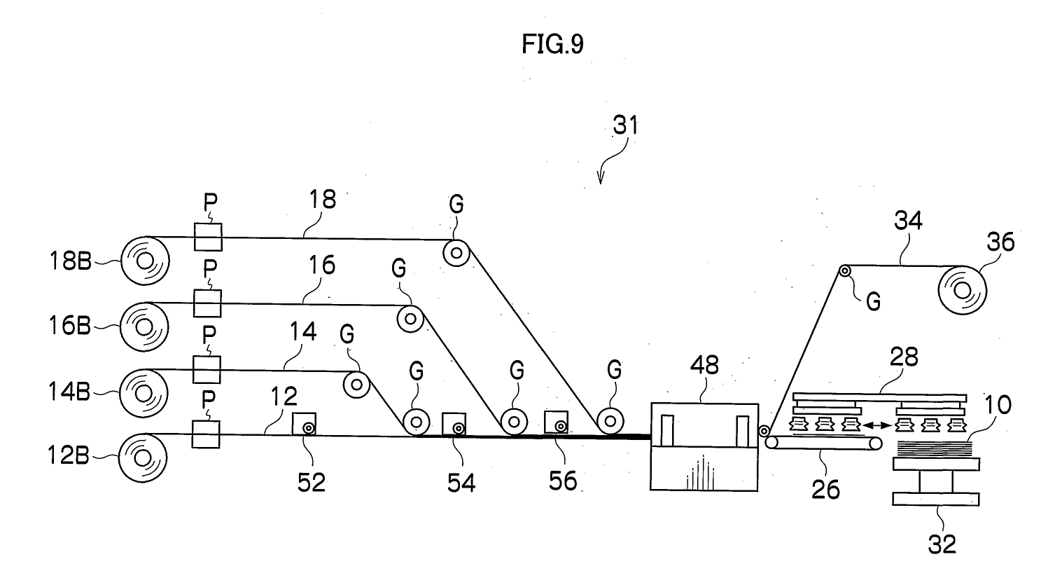

A third method for producing an optical sheet for a display is now described. FIG. 9 is a schematic view of production line for an optical sheet for a display 31 applied to the third method. The same reference numerals are used for members which are the same as or similar to those in the production line for an optical sheet for a display 11 of the first method and the production line for an optical sheet for a display 21 of the second method (see FIGS. 7 and 8), and detailed description thereof is omitted.

In the production line for an optical sheet for a display 31, tape feeders 52, 54, 56 are used instead of the dispensers 42, 44, 46 in the production line for an optical sheet for a display 21. The tape feeders 52, 54, 56 are each a feeder which supplies double-sided adhesive tape from the tip.

The tape feeder 52 supplies double-sided adhesive tape to the surface of the first diffusion sheet 12 to adhere the first diffusion sheet 12 and the first prism sheet 14. The tape feeder 54 supplies double-sided adhesive, tape to the surface of the first prism sheet 14 to adhere the first prism sheet 14 and the second prism sheet 16. The tape feeder 56 supplies double-sided adhesive tape to the second prism sheet 16 to adhere the second prism sheet 16′ and the second diffusion sheet 18.

The double-sided adhesive tape supplied from the tape feeders 52, 54, 56 have adhesive applied to both faces. Highly adhesive acrylic copolymer resin can be used as the adhesive for the double sided adhesive tape. In addition to this, for example, silicon, natural rubber or synthetic rubber adhesive may be used. In consideration of all of heat resistance, physical strength such as creep resistance and costs, acrylic adhesives are preferably used.

For the tape feeders 52, 54, 56 which supply double-sided adhesive tape, commercially available general tape dispensers may be used. The tape feeders 52, 54, 56 are attached to a uniaxial moving mechanism which is movable to any position in the X direction (direction of the width of the sheet), and the position where double-sided adhesive tape is applied can be changed according to punching patterns.

A pivot mechanism is disposed at the part where the tape feeders 52, 54, 56 are fixed. The mechanism is capable of dealing with taping patterns in diagonal directions as well by changing the position of the tape feeders 52, 54, 56 corresponding to the feeding rate of the sheet.

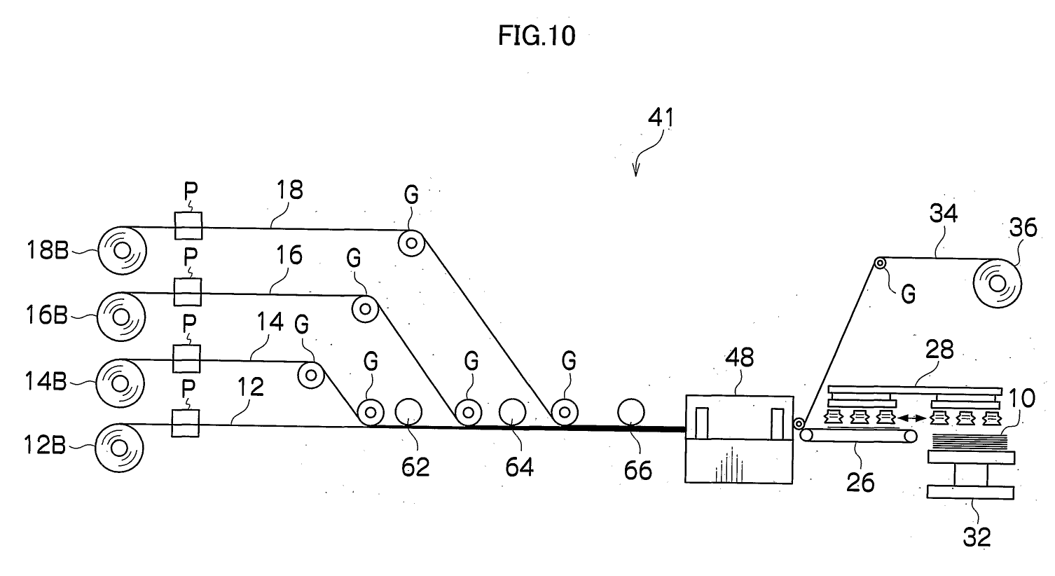

A fourth method for producing an optical sheet for a display is now described. FIG. 10 is a schematic view of production line for an optical sheet for a display 41 applied to the fourth method. The same reference numerals are used for members which are the same as or similar to those in the production lines for an optical sheet for a display of the first to third methods (see FIG. 7 to 9) and detailed description thereof is omitted.

In the production line for an optical sheet for a display 41, ultrasonic horns 62, 64, 66 are used instead of the dispensers 42, 44, 46 in the production line for an optical sheet for a display 21. The ultrasonic horns 62, 64, 66 are each provided at the downstream of press rollers (guide rollers G).

The ultrasonic horns 62, 64, 66 are a device which fuses two or more stacked sheets. Specifically, ultrasonic horn 62 fuses the first diffusion sheet 12′ and the first prism sheet 14. The ultrasonic horn 64 fuses the first prism sheet 14 and the second prism sheet 16. The ultrasonic horn 66 fuses the second prism sheet 16 and the second diffusion sheet 18.

Ultrasonic horns which are moved up and down with an air cylinder or ultrasonic horns which are moved up and down by a servomotor are conventionally known as ultrasonic horns 62, 64, 66 (ultrasonic fusion device). However, any type of ultrasonic fusion device may be employed as long as sheets can be fused by applying ultrasonic vibration with applying load to the sheets.

For controlling the position of ultrasonic horns 62, 64, 66, positions are changed only in the width direction of the sheet when the punching pattern is parallel to the feed direction of the sheet. However, to respond to punching patterns in diagonal directions, an oscillating mechanism which can change the moving direction of the ultrasonic horns 62, 64, 66 to any direction is provided, and the ultrasonic horns 62, 64, 66 are moved in the width direction corresponding to the moving distance of the sheet.

Setting conditions of the ultrasonic horns 62, 64, 66 are determined so that the portion to be fused is not melted down by heat. The portion to be bonded may be cooled after bonding (fusing) using an air cooling mechanism such as air blowing according to need.

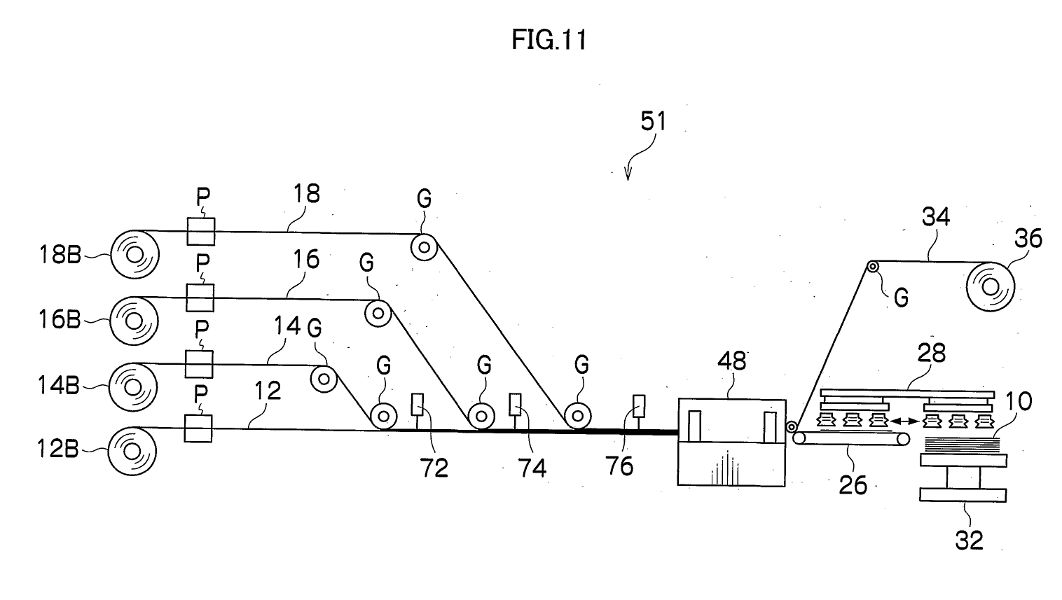

A fifth method for producing an optical sheet for a display is now described. FIG. 11 is a schematic view of production line for an optical sheet for a display 51 applied to the fifth method. The same reference numerals are used for members which are the same as or similar to those in the production lines for an optical sheet for a display of the first to fourth methods and detailed description thereof is omitted.

In the production line for an optical sheet for a display 51, laser heads 72, 74, 76 are used instead of the ultrasonic horns 62, 64, 66 in the production line for an optical sheet for a display 41. The laser heads 72, 74, 76, are each disposed at the downstream of press rollers (guide rollers G) as are the ultrasonic horns 62, 64, 66.

The laser heads 72, 74, 76 are a device which fuses two or more stacked sheets as does the ultrasonic horns 62, 64, 66. Specifically, the laser head 72 fuses the first diffusion sheet 12 and the first prism sheet 14. The laser head 74 fuses the first prism sheet 14 and the second prism sheet 16. The laser head 76 fuses the second prism sheet 16 and the second diffusion sheet 18.

The laser heads 72, 74, 76 are different from the laser head 24 in the production line for an optical sheet for a display 11 of FIG. 7 (the first method), and are used only for the joining step. The cutting step is performed in the punching press device 48. The basic specification and surrounding configurations of the laser heads 72, 74, 76 are substantially the same as those in the first method.

Setting conditions of the laser heads 72, 74, 76 are determined so that the portion to be fused is not melted down by heat. The portion to be bonded may be cooled after bonding (fusing) using an air cooling mechanism such as air blowing according to need.

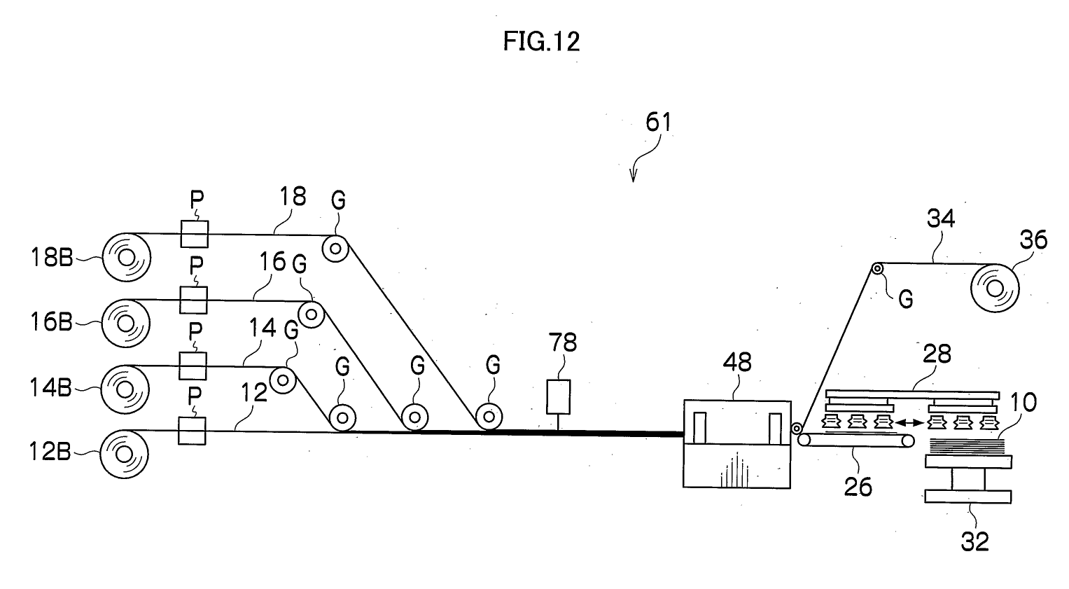

A sixth method for producing an optical sheet for a display is now described. FIG. 12 is a schematic view of production line for an optical sheet for a display 61 applied to the sixth method. The same reference numerals are used for members which are the same as or similar to those in the production lines for an optical sheet for a display of the first to fifth methods (see FIGS. 7 to 11), and detailed description thereof is omitted.

In the production line for an optical sheet for a display 61, a laser head 78 is used instead of the three laser heads 72, 74, 76 in the production line for an optical sheet for a display 51. The laser head 78 is disposed at the downstream of press rollers (guide, rollers G).

The laser head 78 is a device which fuses two or more stacked sheets. Specifically, the laser head 78 fuses a laminate of the first diffusion sheet 12, the first prism sheet 14, the second prism sheet 16 and the second diffusion sheet 18.

The laser head 78 is different from the laser head 24 in the production line for an optical sheet for a display 11 of FIG. 7 (the first method), and is used only for the joining step. The cutting step is performed in the punching press device 48. The basic specification and surrounding configurations of the laser head 78 are substantially the same as those in the first method.

Setting conditions of the laser head 78 are determined so that the portion to be fused is not melted down by heat. The portion to be bonded may be cooled after bonding (fusing) using an air cooling mechanism such as air blowing according to need.

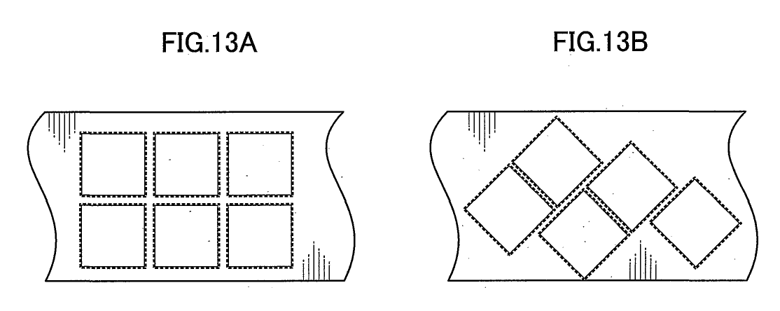

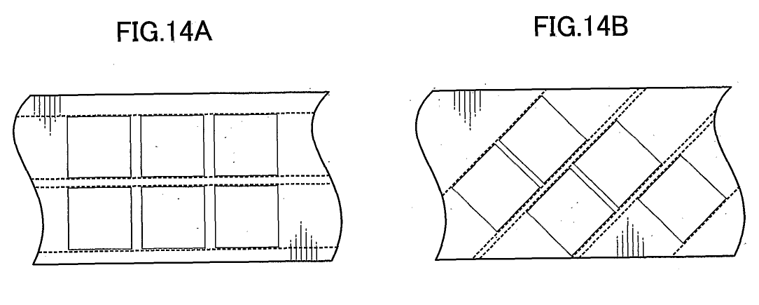

FIGS. 13A and 13B illustrate arrangement of sheets (optical sheets for a display 10 to 60) on a plane, which are punched out from a laminate in the first method. FIGS. 14A and B illustrate arrangement of sheets (optical sheets for a display 10 to 60) on a plane, which are punched out from a laminate in the second to sixth methods.

Referring to FIG. 13A illustrates performing fusing (joining step) and punching (cutting step) parallel to the transferring direction of a laminate. FIG. 13B illustrates performing fusing (joining step) and punching (cutting step) diagonal to the transferring direction of a laminate. In the figures, points on the periphery of sheets that are punched out from the laminate indicate fused portions.

Referring to FIG. 14A illustrates performing fusing or bonding (joining step) in directions parallel to and perpendicular to the transferring direction of a laminate. FIG. 14B illustrates performing fusing or bonding (joining step) in the direction diagonal to the transferring direction of a laminate. In the figures, points on the periphery of sheets that are punched out from the laminate indicate fused portions or bonded portions.

As described above, the present invention can produce a high quality optical sheet in a simple method without decrease in the adhesion strength upon bonding optical sheets when producing an optical sheet for a display.

The present invention also provides the following advantages.

1) Improvement in Product Value by Cost Reduction and Thinning

Since rigidity is required for optical sheets used in large liquid crystal TVs, supports whose thickness is about twice the thickness of conventional supports are used. In contrast, since the optical sheet according to the present invention is a composite of sheets, the composite sheet has sufficient rigidity without increasing the thickness of each layer and the thickness of such layers can be reduced.

2) Improvement in Performance by Preventing Reduction of Converging Effect

To prevent scratches on the lens sheet (make scratches less noticeable), matte treatment is performed on the backside of some products. However, the optical sheet according to the present invention does not require such treatment, and thus not only production cost can be reduced but also reduction of converging effect due to such matte treatment can be prevented, and therefore performance is improved.

3) Improvement in Anti-Fogging Properties

Since a coating film containing a water-soluble antistatic agent and a fluorine surfactant is formed on at least the surface of an optical sheet in a thickness of 0.03 to 0.2 g/m², fogging due to temperature change is significantly improved when the optical sheet for a display of the present invention is used in a backlight unit of a liquid crystal display device.

Embodiments of the method for producing an optical sheet for a display of the present invention have been described above, but the present invention is not limited to the above embodiments and various other aspects are also possible.

For example, although the prism of the first prism sheet 14 and the second prism sheet 16 is always upward in the present embodiments, the sheets can be stacked with the prism downward.

The layer structure of the optical sheet for a display is not limited to those in the embodiments either, and for example, protective sheets can be stacked on the top and the bottom surfaces.

Further, although an aqueous solution containing a water-soluble antistatic agent and a fluorine surfactant is applied using coating device P, P . . . in the line for producing an optical sheet for a display in these embodiments, embodiments in which the solution is applied in the production of a prism sheet or a diffusion sheet can also be applied.

Such configurations function in the same way as in the present embodiments and produce similar effects.

### [Method for Packaging Optical Sheet for Display]

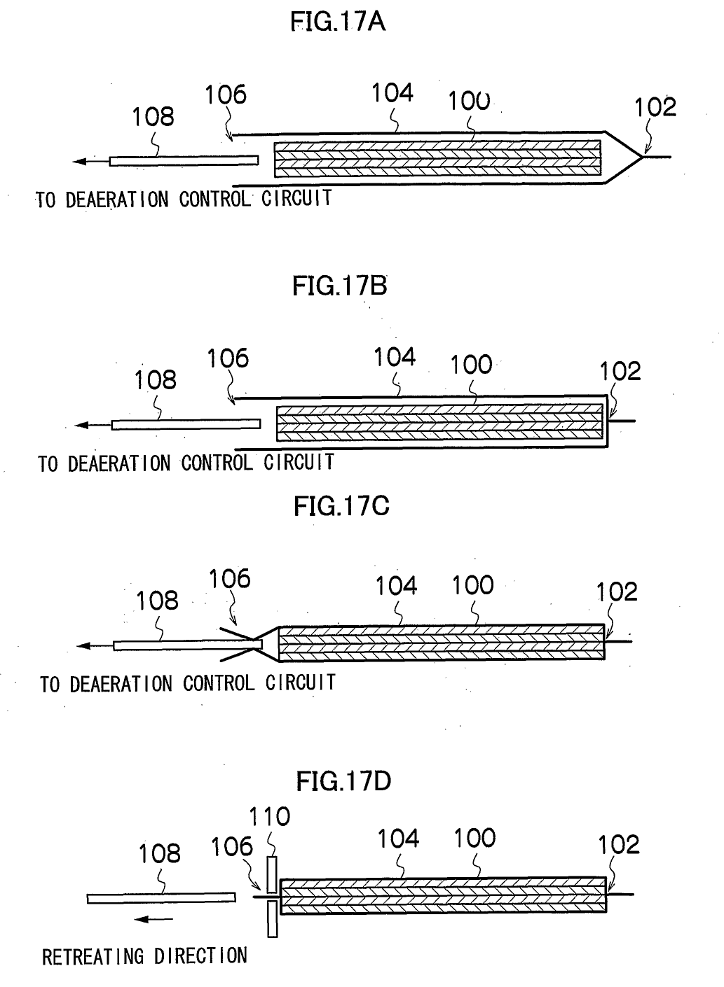

The method for packaging an optical sheet forma display described above is now described with reference to FIGS. 17A to 17D. FIGS. 17A to 17D show a procedure of deaeration packaging in which optical sheets for a display which are bundled in a predetermined number to be packaged (hereinafter a “bundle”) are packaged with deaerating (pressure reduction).

The optical sheet for a display to be packaged through the method is not limited to the optical sheets for a display produced by the above-described methods. The bundles as used herein include not only optical sheets for a display joined at one or more parts shown in FIG. 1 to FIG. 6, but also combination of a light diffusion sheet and a prism sheet which are not bonded and are bundled in an order to be installed in a backlight unit.

Configurations of light diffusion sheets and prism sheets to which the packaging method shown in this embodiment can be suitably applied include (1) combination of a second light diffusion sheet 18 and a first prism sheet 14 (the optical sheet for a display 60 in FIG. 6), (2) combination of a second light diffusion sheet 18, a second prism sheet 16 and a first prism sheet 14 (the optical sheet for a display 50 in FIG. 5), (3) combination of a second diffusion sheet 18, a first prism sheet 14, and a first diffusion, sheet 12 (the optical sheet for a display 30 of FIG. 3), (4) combination of a second diffusion sheet 18, a second prism sheet 16, a first prism sheet 14 and a first diffusion sheet 12 (the optical sheet for a display 10 in FIG. 1), (5) combination of a first prism sheet 14 and a first diffusion sheet 12 (the optical sheet for a display 40 in FIG. 4), and (6) combination of a second prism sheet 16, a first prism sheet 14 and a first diffusion sheet 12 (the optical sheet for a display 20 in FIG. 2).

In the combinations of a light diffusion sheet and a prism sheet (1) to (6), the first diffusion sheet 14 and the second diffusion sheet 18 may be accordingly exchanged, or the first prism sheet 14 and the second prism sheet 16 may be accordingly exchanged. For example, in the combination of the light diffusion sheet and the prism sheet shown in (1), a second prism sheet may be combined with the second diffusion sheet 18 instead of the first prism sheet 14.

In aspects using the first prism sheet 14 and the second prism sheet 16, the respective prism sheets are disposed so that the axes of the convex lenses of the prism sheets are substantially at right angles (ridgeline directions of the convex lenses of the prism sheets are substantially at right angles).

In the temporary packaging step shown in FIG. 17A, a bundle 100 (laminate) is inserted into a packaging bag 104 (packaging material) whose one end (first end 102) is previously sealed and an air suction nozzle 108 (deaeration device) for removing air in the packaging bag 104 is put into an opening (second end 106) on the other end. A heat seal mechanism (not shown in FIG. 17A, shown by reference numeral 110 in FIG. 17D) longer than the width of the packaging bag 104 is disposed above and below the air suction nozzle 108. The bundle 100 and the packaging bag 104 shown in FIG. 17A are held at the bottom in the FIG. 17A.

Upon temporary packaging of the non-bonded combination of a light diffusion sheet and a prism sheet bundled in an order to be installed in a backlight unit, the sheets are handled with one end being clipped (the left end in FIG. 17A in this embodiment).

In the deaeration step shown in FIG. 17B, the air in the packaging bag 104 is removed by operating a vacuum pump connected to the air suction nozzle 108, which is not shown, by a deaeration control circuit (not shown) (pressure reduction), thereby allowing the packaging bag 104 to shrink. FIG. 17C shows an advanced state of shrinkage of the packaging bag 104. When the pressure in the packaging bag 104 is reduced, air and contaminants (dust) in the packaging bag 104 are discharged to the outside. Further, since the bundle 100 is appropriately fixed to the packaging bag 104, generation of dust, formation of scratches and generation of electrostatic charge due to friction between sheets constituting the bundle or between the bundle and the packaging bag 104 can be prevented.

In the deaeration step, the inside of the packaging bag 104 in which the bundle 100 is temporarily packaged may be brought into a vacuum condition at a predetermined degree of vacuum.

In the sealing step shown in FIG. 17D, the air suction nozzle 108 is retreated in the retreating direction (shown by an arrow in the figure) when the packaging bag 104 is completely shrunk (namely, the bundle 100 and the packaging bag 104 are appropriately brought into close contact and the bundle 100 is fixed to the packaging bag 104). Simultaneously, the second end 106 shown in FIGS. 17A to 17C is heat-sealed by the heat seal mechanism 110 to form a sealed part 116.

To ensure close contact with the bundle 100, preferably the packaging bag 104 has a predetermined elasticity at least at a portion where the bag comes into contact with the bundle 100. Examples of materials having a predetermined elasticity include PVC (polyvinyl chloride), PP (polypropylene), PE (polyethylene), PS (polystyrene), PO (polyolefin) and PET (polyethylene terephthalate). The above materials are heat-shrinkable and when heat is applied upon sealing (employing shrink packaging together), the contact between the packaging bag 104 and the bundle 100 (air tightness of the packaging bag 104) is increased.

The packaging method described above reduces defects in bundles due to scratches or attachment of contaminants and eliminates assembling steps and inspection steps. The method also contributes to cost reduction because the number of protective sheets can be reduced.

### EXAMPLES

Examples of optical sheets for a display produced by the method of the present invention are now described.

### [Preparation of Prism Sheet]

A prism sheet used for the first prism sheet 14 and the second prism sheet 16 was prepared. The prism sheet is commonly used for the first prism sheet 14 and the second prism sheet 16.

Preparation of Resin Solution

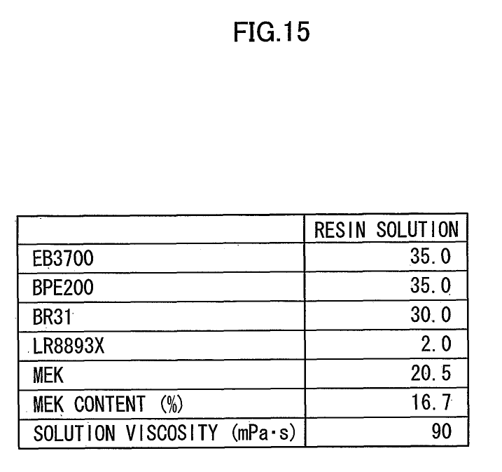

Compounds listed in the table of FIG. 15 were mixed at weight ratios shown in the table. The mixture was heated to 50° C. and the compounds were dissolved with stirring to give a resin solution. The name and the type of the compounds are as follows.

EB3700: Ebecryl 3700 available from Daicel UCB Corporation, bisphenol A epoxyacrylate, (viscosity: 2200 mPa·s/65° C.)

BPE200: NK Ester BPE-200 available from SHIN-NAKAMURA CHEMICAL CORPORATION, dimethacrylate of ethylene oxide adduct bisphenol A (viscosity: 590 mPa·s/25° C.)

BR-31: New Frontier BR-31 available from DAI-ICHI KOGYO SEIYAKU CO., LTD., tribromophenoxyethyl acrylate (solid at room temperature, melting point 50° C. or higher)

LR8893X: Lucirin LR8893X, radical generator available from BASF, ethyl-2,4,6-trimethylbenzoyl ethoxyphenylphosphine oxide

MEK: methyl ethyl ketone

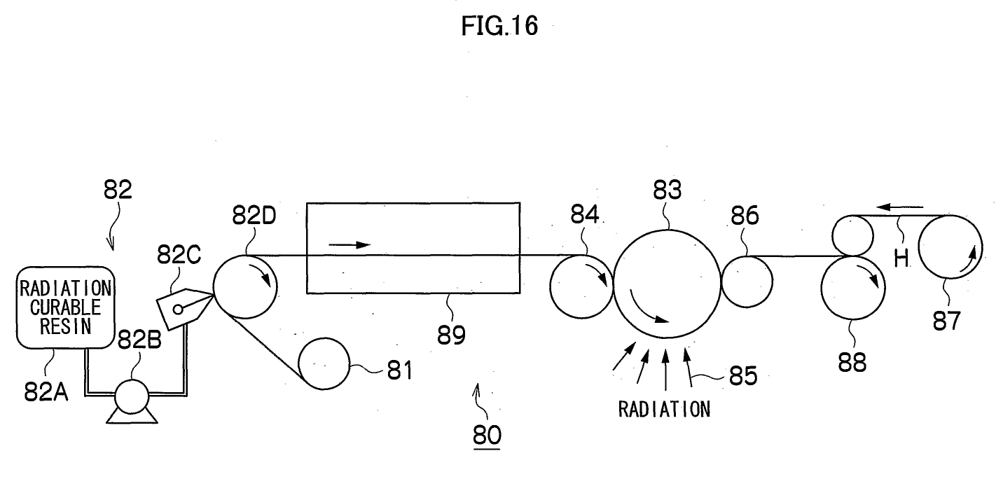

A prism sheet was produced using an apparatus for producing a prism sheet having a configuration shown in FIG. 16.

A transparent PET (polyethylene terephthalate) film having a width of 500 mm and a thickness of 100 μm was used as sheet W.

A roller having a length (in the direction of the width of the sheet W) of 700 mm and a diameter of 300 mm made of S45C whose surface is made of nickel was used as an emboss roller 83. Grooves with a pitch of 50 μm in the roller axis direction were formed on the surface of the roller in a width of about 500 mm across the entire circumference by cutting using a diamond tool (single point). The cross-section of the groove is a triangle having an apex angle of 90 degrees, and the bottom of the groove is also a triangle of 90 degrees without flat part. In other words, the groove has a width of 50 μm and a depth of about 25 μm. The groove is endless without joints in the circumferential direction of the roller. Thus, a lenticular lens (prism sheet) having a triangle cross section can be formed on the sheet W by the emboss roller 83. The surface of the roller is plated with nickel after making the groove.

A die coater with an extrusion type application head 82C was used as an application device 82.

A solution having a composition described in the table of FIG. 15 was used as a coating solution F (resin solution). The amount of the coating solution F fed to the coating head 82C was controlled by a feeder 82B so that the coating solution F (resin) has a film thickness of 20 μm in a wet state after removing an organic solvent by drying.

A hot air circulating drier was used as a drying device 89. The temperature of the hot air was 100° C. A roller having a diameter of 200 mm and on which a layer of silicon rubber having a rubber hardness of 90 is formed was used as a nip roller 84. The nip pressure (effective nip pressure) for pressing the sheet W with the emboss roller 83 and the nip roller 84 was 0.5 Pa.

A metal halide lamp was used as a device for curing resin 85 and irradiation was performed at a dose of 1000 mJ/cm².

A prism sheet having an irregularity pattern was prepared by the above method.

### [Preparation of First Diffusion Sheet 12]

A first diffusion sheet 12 (lower diffusion sheet) was prepared by forming an undercoat layer, a backcoat layer and a light diffusion layer in that order by the following method.

Undercoat Layer

A solution A having the following composition which is a coating solution for an undercoat layer was applied to one surface of a polyethylene terephthalate film (support) having a thickness of 100 μm with a wire bar (wire bar size: #10). The solution was dried at 120° C. for 2 minutes to give an undercoat layer having, a film thickness of 1.5 μm.

(Coating solution for undercoat layer)

| | |
|---|---|
| methanol | 4165 g |
| JURYMER SP-50T (available from NIHON JUNYAKU | 1495 g |
| Co., Ltd.) | |
| cyclohexanone | 339 g |
| JURYMER MB-1X (available from NIHON JUNYAKU | 1.85 g |
| Co., Ltd.) | |

(organic particles: cross linked polymethyl methacrylate, ultrafine spherical particles having a weight average particle size of 6.2 μm)

Backcoat Layer

A solution B having the following composition which is a coating solution for a backcoat layer was applied to a surface of the support opposite from where the undercoat layer was applied with a wire bar (wire size: #10). The solution was dried at 120° C. for 2 minutes to give a backcoat layer having a film thickness of 2.0 μm.

(Coating solution for backcoat layer)

| | |
|---|---|
| methanol | 4171 g |
| JURYMER SP-65T (available from NIHON JUNYAKU | 1487 g |
| Co., Ltd.) | |
| cyclohexanone | 340 g |
| JURYMER MB-1X (available from NIHON JUNYAKU | 2.68 g |
| Co., Ltd.) | |

(organic particles: crosslinked polymethyl methacrylate, ultrafine spherical particles having a weight average particle size of 6.2 μm)

Light Diffusion Layer

A solution C having the following composition which is a coating solution for a light diffusion layer was applied to the undercoat layer side of the support prepared above with a wire bar (wire size: #22). The solution was dried at 120° C. for 2 minutes to give a light diffusion layer. As described later, a light diffusion layer was prepared by applying the solution C immediately after preparation of the solution or applying the solution C after allowing the solution to stand for two hours after preparation.

(Coating solution for light diffusion layer)

| | |
|---|---|
| cyclohexanone | 20.84 g |
| DISPARLON PFA-230, solid concentration 20% by mass | 0.74 g |
| (particle anti-settling agent: fatty acid amide available from | |
| Kusumoto Chemicals, Ltd.) | |
| 20% by mass acrylic resin (DIANAL BR-117 available from | 17.85 g |
| Mitsubishi Rayon Co., Ltd.) solution in methyl ethyl ketone | |
| JURYMER MB-20X (available from NIHON JUNYAKU | 11.29 g |
| Co., Ltd.) (organic particles: crosslinked polymethyl | |
| methacrylate, ultrafine spherical particles having a | |
| weight average particle size of 18 μm) | |
| F780F (available from Dainippon Ink & Chemicals | 0.03 g |
| Incorporated) (30% by mass methyl ethyl ketone solution) | |

### [Preparation of Second Diffusion Sheet 18]

A second diffusion sheet 18 (upper diffusion sheet) was prepared under the same condition and the same flow as in the above-described first diffusion sheet 12 except that the amount added of JURYMER MB-20X in the light diffusion layer of the first diffusion sheet 12 is changed to 1.13 g from 11.29 g.

### [Preparation of Optical Sheet for Display 10]

Each sheet (a first diffusion sheet 12, a first prism sheet 14, a second prism sheet 16 and a second diffusion sheet 18) is exposed to fine mist of an aqueous solution containing 2% by weight of stearyltrimethylammonium chloride and 0.2% by weight of a fluorine nonionic surfactant using a commercially available ultrasonic oscillating aerosol spraying apparatus for 5 seconds. The sheets were air dried and sheets having a coating film with a film thickness of 0.04 g/m² were obtained. The surface resistivity of the samples was measured. In addition, the light diffusion sheets and the prism sheets were stacked and the four sides of the sheets were bonded by a commercially available ultrasonic welding sealing apparatus to give a composite sheet.

### Preparation of Optical Sheet for Display

### Comparative Example

A composite sheet was prepared by a method in which the sheets (the first diffusion sheet 12, the first prism sheet 14, the second prism sheet 16 and the second diffusion sheet 18) were stacked and the four sides of the sheets were bonded by a commercially available ultrasonic welding sealing apparatus.

### [Evaluation of Optical Sheet For Display]

The optical sheets for a display in Examples have a surface specific resistivity of 2.5×10¹⁰ ω, which is sufficiently small for preventing attachment of dust. The sheets also have sufficient adhesion strength so that the sheets are not separated in usual handling, and have no problem of optical properties and appearance.

For comparing adhesion strength, 100 sets each of the optical sheets of Example and Comparative Example were usually handled and those with separation were marked NG. Of the 100 sets of the Example, only 1 set was marked NG. In contrast, of the 100 sets of the Comparative Example, 24 sets were marked NG. The result of the comparison shows that the optical sheet of Example of the present invention has anti-static effects and improved adhesiveness between sheets.

1. An optical sheet for a display comprising, two or more optical sheets which are stacked and bonded at one or more parts, wherein
a coating film containing a water-soluble antistatic agent and a fluorine surfactant is formed on at least one side of each bonding surface of the two or more optical sheets in a thickness of 0.03 to 0.2 g/m².

2. An optical sheet for a display, comprising:
a lens sheet in which convex lenses are formed adjacent to each other in an axial direction almost on the whole area; and
a light diffusion sheet stacked on a surface and/or a backside of at least one lens sheet, wherein
the lens sheet and the light diffusion sheet are bonded at one or more parts, and
a coating film containing a water-soluble antistatic agent and a fluorine surfactant is formed on at least one side of each bonding surface of the lens sheet and the light diffusion sheet in a thickness of 0.03 to 0.2 g/m².

3. An optical sheet for a display comprising, two lens sheets which are stacked and in which convex lenses are formed adjacent to each other in an axial direction almost on the whole area and a light diffusion sheet stacked on a surface and/or a backside of a laminate of the lens sheets, wherein
the lens sheets themselves and the lens sheets and the light diffusion sheet are bonded at one or more parts, and
a coating film containing a water-soluble antistatic agent and a fluorine surfactant is formed on at least one side of each bonding surface of the lens sheets themselves and the lens sheets and the light diffusion sheet in a thickness of 0.03 to 0.2 g/m².

4. The optical sheet for a display according to claim 1, wherein
the water-soluble antistatic agent is a cationic antistatic agent.

5.-16. (canceled)

17. The optical sheet for a display according to claim 2, wherein
the water-soluble antistatic agent is a cationic antistatic agent.

18. The optical sheet for a display according to claim 3, wherein
the water-soluble antistatic agent is a cationic antistatic agent.

19. A method for producing an optical sheet for a display, comprising the steps of:
forming a coating film of an aqueous solution containing a water-soluble antistatic agent and a fluorine surfactant on at least one side of each bonding surface of two or more optical sheets whose plane size is equal to or larger than a product size in a thickness after drying of 0.03 to 0.2 g/m²;
stacking the two or more optical sheets whose plane size is equal to or larger than a product size;
joining the two or more optical sheets at one or more parts; and
cutting a laminate of the two or more optical sheets into the product size.

20. A method for producing an optical sheet for a display, comprising the steps of:
forming a coating film of an aqueous solution containing a water-soluble antistatic agent and a fluorine surfactant on at least one side of each bonding surface of a lens sheet in which convex lenses are formed adjacent to each other in an axial direction almost on the whole area and whose plane size is equal to or larger than a product size and a light diffusion sheet whose plane size is equal to or larger than a product size in a thickness after drying of 0.03 to 0.2 g/m²;
stacking the light diffusion sheet on a surface and/or a backside of at least one lens sheet;
joining the lens sheet and the light diffusion sheet at one or more parts; and
cutting a laminate of the light diffusion sheet and the lens sheet into the product size.

21. A method for producing an optical sheet for a display, comprising the steps of:
forming a coating film of an aqueous solution containing a water-soluble antistatic agent and a fluorine surfactant on at least one side of each bonding surface of a lens sheet in which convex lenses are formed adjacent to each other in an axial direction almost on the whole area and whose plane size is equal to or larger than a product size and a light diffusion sheet whose plane size is equal to or larger than the product size in a thickness after drying of 0.03 to 0.2 g/m²;
stacking two of the lens sheet and stacking the light diffusion sheet on a surface and/or a backside of a laminate of the lens sheets;
joining the lens sheets themselves and the lens sheets and the light diffusion sheet at one or more parts; and
cutting periphery of a laminate of the light diffusion sheet and the lens sheets into the product size.

22. The method for producing an optical sheet for a display according to claim 19, wherein
coating in the step of coating film forming is performed by an aerosol spraying method.

23. The method for producing an optical sheet for a display according to claim 20, wherein
coating in the step of coating film forming is performed by an aerosol spraying method.

24. The method for producing an optical sheet for a display according to claim 21, wherein
coating in the step of coating film forming is performed by an aerosol spraying method.

25. A package of an optical sheet for a display, comprising a laminate of a product size in which two or more kinds of optical sheets are stacked in a predetermined order and which is packaged in a packaging material, wherein
the packaging material is sealed by reducing pressure with the packaging material being brought into close contact with the laminate.

26. A package of an optical sheet for a display, comprising a laminate of a product size in which two or more kinds of optical sheets are stacked in a predetermined order and periphery of the optical sheets is joined at one or more parts and which is packaged in a packaging material, wherein
the packaging material is sealed by reducing pressure with the packaging material being brought into close contact with the laminate.

27. The package of an optical sheet for a display according to claim 25, wherein the optical sheets include a lens sheet and a diffusion sheet.

28. The package of an optical sheet for a display according to claim 26, wherein the optical sheets include a lens sheet and a diffusion sheet.

29. The package of an optical sheet for a display according to claim 25, wherein the optical sheets include a stacked lens sheet in which a plurality of lens sheets are stacked and a diffusion sheet.

30. The package of an optical sheet for a display according to claim 26, wherein the optical sheets include a stacked lens sheet in which a plurality of lens sheets are stacked and a diffusion sheet.

31. The package of an optical sheet for a display according to claim 25, wherein
the optical sheets in the laminate are stacked in an order to be installed in a backlight unit.

32. The package of an optical sheet for a display according to claim 26, wherein
the optical sheets in the laminate are stacked in an order to be installed in a backlight unit.

33. The package of an optical sheet for a display according to claim 25, wherein
the packaging material has a predetermined elasticity at least at a portion where the member comes into contact with the laminate.

34. The package of an optical sheet for a display according to claim 26, wherein
the packaging material has a predetermined elasticity at least at a portion where the member comes into contact with the laminate.

35. A method for packaging an optical sheet for a display, comprising the steps of:
temporarily packaging a laminate of a product size in which two or more kinds of optical sheets are stacked in a predetermined order in a packaging material;
reducing the pressure in the packaging material so that the packaging material is brought into close contact with the laminate; and
sealing the packaging material with the packaging material being brought into close contact with the laminate.

36. A method for packaging an optical sheet for a display, comprising the steps of:
joining a laminate of a product size in which two or more kinds of optical sheets are stacked in a predetermined order at one or more parts of the periphery of the optical sheets;
temporarily packaging the laminate whose periphery is joined at one or more parts in the joining step in a packaging material;
reducing the pressure in the packaging material so that the packaging material is brought into close contact with the laminate; and
sealing the packaging material with the packaging material being brought into close contact with the laminate.
